(19) United States
(12) Patent Application Publication
(10) Pub. No.: US 2025/0145541 A1
(43) Pub. Date: May 8, 2025

(54) REFRACTORY MATERIALS

(71) Applicant: Honeywell International Inc., Charlotte, NC (US)

(72) Inventors: Mehrad Mehr, Morristown, NJ (US); Bahram Jadidian, Watchung, NJ (US); Kevin Blinn, Franklin Park, NJ (US)

(21) Appl. No.: 18/504,894

(22) Filed: Nov. 8, 2023

(51) Int. Cl. C04B 41/50; C04B 35/591; C04B 35/65; C04B 41/45; C04B 41/87

(52) U.S. Cl. CPC C04B 41/5059; C04B 35/591; C04B 35/65; C04B 41/4558; C04B 41/87; C04B 2235/3873; C04B 2235/428; C04B 2235/9676

(57) ABSTRACT

In some examples, a method for making a refractory component includes depositing carbon on a surface of a refractory substrate. The carbon fills surface voids on the surface of the refractory substrate. A melting point of the refractory substrate is greater than or equal to about 1500 degrees Celsius (° C.). The method includes applying a metal slurry to a surface of the refractory substrate following the deposition of the carbon and reacting a metal of the metal slurry with the carbon to form a metal carbide phase within the surface voids of the refractory substrate.

### TECHNICAL FIELD

The disclosure relates to refractory materials.

### BACKGROUND

Refractory materials may be used in high temperature applications to aid in handling molten metals. For example, in foundries, refractory materials may be used to form or coat metal processing units, such as ladles and furnaces. Due to harsh conditions experienced during metal processing, the metal processing units may undergo corrosion and erosion, which may result in replacement of the entire metal processing unit.

### SUMMARY

The disclosure describes systems and techniques for forming an article from one or more refractory materials. An article, such as a refractory component or aerospace component, may be a portion of a device or system that is subject to a relatively high temperature oxidative environment, such as molten metal processing having temperatures greater than about 1200 degrees Celsius (° C.) or hypersonic aerospace operation. To prevent slag or other oxidative species from degrading the refractory or aerospace component, surfaces of the refractory component that may be exposed to the oxidative species are dense and have a high resistance to penetration of the oxidative species.

In some examples, rather than form the entire refractory component from dense refractory materials, which may be prohibitively expensive or difficult to fabricate, the refractory component is formed from a porous refractory material. Pores (or other voids) in a surface of the porous refractory material are sealed with a metal carbide phase. The metal carbide phase is formed by at least depositing carbon into the pores on the surface of the porous refractory material and reacting the carbon with metal from a metal slurry. The carbon and metal feedstocks used to form the metal carbide phase may be relatively inexpensive compared to preceramic polymers or other materials used to form metal carbides. The resulting refractory component has a dense surface portion that resists penetration of molten metals, thereby enabling porous refractory materials to be used for forming refractory components.

In some examples, the porous refractory material includes silicon nitride. Silicon nitride has a relatively high mechanical strength and high surface porosity that may otherwise make the substrate unsuitable for direct contact with oxidative species but for the dense metal carbide phase described above. The silicon nitride may be formed from relatively inexpensive feedstock, such as silicon powder, that may be pressed into a shape of the refractory component and heat treated in the presence of nitrogen gas to form the silicon nitride. The surface of the silicon nitride may be sealed with a metal carbide phase, such as a silicon carbide phase, as described above. The resulting refractory component has a high mechanical strength and high resistance to oxidation, and can be formed by a relatively inexpensive and simple process.

In one example, a method for making a refractory component includes depositing carbon within surface voids of a refractory substrate. A melting point of the refractory substrate is greater than or equal to about 1500 degrees Celsius (° C). The method further includes applying a metal slurry to the refractory substrate following the deposition of the carbon and reacting a metal of the metal slurry with the carbon to form a metal carbide phase within the surface voids of the refractory substrate.

In another example, the method described above includes forming the refractory substrate to include silicon nitride. Prior to deposition of the carbon layer, the method includes pressure casting silicon powder into a mold having a predetermined shape corresponding to the shape of the refractory component and reacting the silicon powder with nitrogen gas to form the refractory substrate.

In another example, an article of a foundry system includes a refractory component defining an oxidation-resistant surface configured to contact molten metal. The refractory component includes a refractory substrate and a metal carbide phase within surface voids of the refractory substrate. A melting point of the refractory substrate is greater than or equal to about 1500 degrees Celsius (° C.).

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a cross-sectional perspective view diagram illustrating an example vessel that includes a refractory component formed in accordance with the techniques of this disclosure.

FIG. 2A is a cross-sectional side view diagram of a portion of an example refractory component formed in accordance with the techniques of this disclosure.

FIG. 2B is a cross-sectional expanded side view diagram of the portion of the example refractory component of FIG. 2A formed in accordance with the techniques of this disclosure.

FIG. 2C is a cross-sectional expanded side view diagram of the portion of the example refractory component of FIG. 2A formed in accordance with the techniques of this disclosure.

FIG. 3A is a flow diagram illustrating an example technique for forming a refractory component in accordance with the techniques of this disclosure.

FIG. 3B is a flow diagram illustrating an example technique for forming a refractory component in accordance with the techniques of this disclosure.

FIG. 4A is a cross-sectional side view diagram of a portion of an example refractory substrate that includes surface voids, formed in accordance with the techniques of this disclosure.

FIG. 4B is a cross-sectional side view diagram of a portion of an example refractory substrate and an example carbon phase, formed in accordance with the techniques of this disclosure.

FIG. 4C is a cross-sectional side view diagram of a portion of an example refractory substrate, an example carbon phase, and an example metal slurry, formed in accordance with the techniques of this disclosure.

FIG. 4D is a cross-sectional side view diagram of a portion of an example refractory substrate and an example metal carbide phase, formed in accordance with the techniques of this disclosure.

FIG. 5A is a cross-sectional expanded side view diagram of a portion of an example refractory component formed in accordance with the techniques of this disclosure.

FIG. 5B is a cross-sectional expanded side view diagram of the portion of a refractory substrate of the example refractory component of FIG. 5A formed in accordance with the techniques of this disclosure.

FIG. 6 is a flow diagram illustrating an example technique for forming a refractory component in accordance with the techniques of this disclosure.

### DETAILED DESCRIPTION

The disclosure describes articles, such as high temperature articles of foundry systems, that include refractory materials, such as a porous refractory material and a dense silicon carbide coating on various surfaces of the porous refractory material. Refractory components made from refractory materials may be capable of operating in relatively high temperature oxidative environments. For example, foundry refractory materials may aid in the handling of molten metals during metalworking, such as steelmaking. Various foundry systems, such as ladles, slide gates, and furnaces, may include refractory components, such as bricks, bulk materials, or liners, to assist in maintaining high temperatures of the molten metals and shield more sensitive components of the processing units and workers operating the processing units from the high temperatures. These refractory components may provide high resistance to oxidation and/or environmental attack at high temperatures experienced during fabrication of aerospace components, as well as other types of components.

Refractory materials may be formed from relatively inexpensive refractory ceramic particles dispersed in a ceramic matrix. Despite a relatively high thermal and chemical stability of the refractory materials, the harsh environment of the molten metals may erode and corrode the ceramic matrix of the refractory components. For example, ladles for processing steel may be formed from refractory materials that include refractory particles bonded by a carbon matrix. Slag and other byproducts of steel processing may oxidize the carbon and cause cracking or other degradation in the refractory materials. As a result, the refractory components may be periodically replaced or rebuilt.

Refractory components described herein include a high temperature refractory substrate that may be stable up to relatively high temperatures, such as greater than or equal to about 1500° C. In some examples, the refractory substrate is a porous refractory substrate that includes pores or other surface voids on various surfaces of the refractory substrate. Porous refractory substrates may be formed from inexpensive ceramic particles dispersed in a ceramic matrix. Surfaces that are configured to contact molten metal include an oxidation-resistant metal carbide phase having a high density that fills surface voids on the surface of the porous refractory substrate to seal the porous refractory substrate and limit oxidative species from migrating into the porous refractory substrate and/or contaminants from migrating from the porous refractory substrate. This dense metal carbide phase may enable fabrication of refractory components from relatively inexpensive porous refractory materials that may otherwise be susceptible to oxidation.

The porous refractory materials may include reaction-bonded silicon-based refractory materials, which may be particularly inexpensive to fabricate and resistant to high temperatures, such as greater than or equal to about 1200° C. For example, the porous refractory substrate may be formed from reaction-bonded silicon nitride having a near net shape as a silicon preform. Silicon particles may be pressure casted into the silicon preform and heated in an atmosphere of nitrogen gas to react the silicon with the nitrogen gas and form the silicon nitride.

To form the metal carbide phase, dense carbon is deposited within surface voids on the surface of the porous refractory substrate. The carbon is subsequently reacted with a metal of a metal slurry to form the metal carbide phase, which extends into the surface voids on the surface of the porous refractory substrate to protect the refractory substrate from oxidative species.

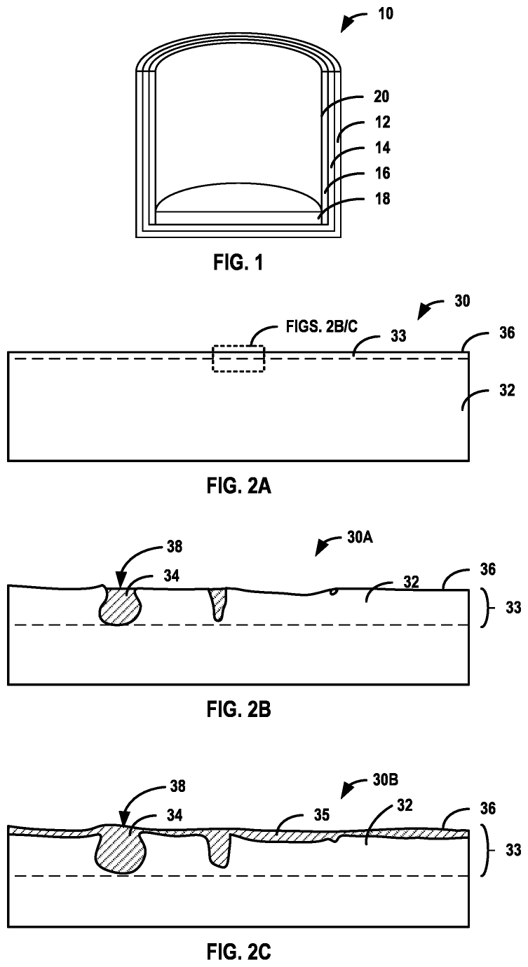

Refractory components described herein may be used in a variety of high temperature applications. FIG. 1 is a cross-sectional perspective view diagram illustrating an example vessel 10 that includes a refractory component 16 formed in accordance with the techniques of this disclosure. FIG. 1 illustrates an example of an example high temperature article (vessel 10) configured to handle molten materials. Such high temperature articles include one or more surfaces that contact molten metal and experience high temperatures conducive to oxidation, and so may include refractory components to resist oxidation.

Vessel 10 includes a casing 12, an insulating layer 14, refractory component 16, and a bottom 18 that may include a heating system (not shown). Refractory component 16 is an innermost component contacting contents of vessel 10, insulating layer 14 is positioned around refractory component 16 to retain heat within vessel 10, and casing 12 is positioned around insulating layer 14 to contain insulating layer 14 and provide structure to vessel 10. Vessel 10 may be configured to process molten metal, such as steels. For example, vessel 10 may be a crucible for melting metal or a ladle for transporting molten metal. Surfaces of vessel 10 in contact with molten metal may experience oxidation and corrosion due to impurities in the metal. For example, melting various metals used for steel may cause calcium and silicon to come into solution and form byproducts such as calcium-rich silicates.

To help resist corrosion and oxidation from these byproducts, vessel 10 includes refractory component 16. Refractory component 16 may form at least a portion of an interior portion of vessel 10, and may include an oxidation-resistant surface 20 configured to contact molten metal. While refractory component 16 is illustrated as being a monolithic component, refractory component 16 may be formed from one or more portions, such as bricks.

As will be discussed further below, in some examples, refractory component 16 includes a porous refractory substrate and a metal carbide phase within surface voids of the porous refractory substrate. The porous refractory substrate is configured to resist very high temperatures, such as greater than or equal to about 1500 degrees Celsius (° C.), while the metal carbide phase fills the surface voids on the surface of the porous refractory substrate, is chemically stable in the presence of reactive byproducts of the molten metal, and resists penetration of oxidizing species.

FIG. 2A is a schematic side view diagram of a portion 30 of an example refractory component formed in accordance with the techniques of this disclosure. The refractory component, such as refractory component 16 of FIG. 1, may be subject to relatively high temperatures and oxidative conditions during operation. As one example, as described in FIG. 1 above, metal processing components may be exposed to temperatures above 2200 degrees Fahrenheit (° F.) (about 1200 degrees Celsius (° C.)), such as during processing of superalloys and steel. In addition, the melt contacting these components may include oxidative and other reactive species, such as unremoved oxygen and alkaline metals from slag.

Portion 30 includes a porous refractory substrate 32 formed from a high temperature refractory material. A high temperature refractory material may include any non-metallic material that maintains thermal and chemical stability at temperatures at or above about 1500 degrees Celsius (° C.). A high thermal stability may include a high melting point, a low amount of thermal expansion in response to a change in temperature, a high dimensional stability when exposed to high temperatures for an extended period of time, a low change in strength in response to a change in temperature, and/or a low thermal conductivity. For example, a melting point or thermal degradation temperature of porous refractory substrate 32 may be greater than or equal to about 1500° C.

A composition of the high temperature refractory material of porous refractory substrate 32 may be selected for a variety of properties including, but not limited to, one or more of a melting point of the refractory material, a coefficient of thermal expansion of the refractory material, a thermal conductivity of the refractory material, or the like. For example, a melting or softening point of porous refractory substrate 32 may be higher than an anticipated temperature encountered by portion 30 of the refractory component during operation. In some examples, porous refractory substrate 32 may have a melting point greater than about 1600°° C., such as greater than about 2400° C. Example refractory materials used for porous refractory substrate 32 may include, but are not limited to, magnesium oxide (magnesia), aluminum oxide (alumina), silicon dioxide (silica), silicon nitride, calcium oxide (calcia), ferric oxide, titanium oxide (titania), silicates, zirconia, chamotte, combinations thereof, and other refractory ceramic materials. In some examples, porous refractory substrate 32 includes magnesium oxide. For example, magnesium oxide formed at high temperatures (e.g., greater than 1500° C.) may be physically and chemically stable at high temperatures experienced during metal processing, and may be relatively inexpensive and easily obtained.

Porous refractory substrate 32 may be relatively inexpensive to fabricate. For example, porous refractory substrate 32 may be manufactured from relatively inexpensive feedstocks and/or manufactured using relatively inexpensive processes. Inexpensive feedstocks may include metal powders, such as silicon powders, that are capable of reacting with reactive gases to form silicon-based refractory materials; refractory precursors that are capable of decomposing to form refractory materials; and the like.

In some examples, porous refractory substrate 32 includes reaction-bonded silicon-based refractory materials, which may be particularly inexpensive to fabricate and resistant to high temperatures. Silicon particles may be pressure casted into a silicon preform and heated in a reactive atmosphere to react the silicon with a reactive gas and form the reaction-bonded silicon-based refractory material. As will be described further below, the porous refractory substrate may be formed from reaction-bonded silicon nitride having a near net shape as a silicon preform. Silicon nitride may be physically and chemically stable at high temperatures experienced during metal processing.

Porous refractory substrate 32 may have a relatively high porosity. Porosity refers to a volume fraction of pores in porous refractory substrate 32, and includes pores (or voids) connected to a surface of porous refractory substrate 32, or open pores. In some examples, a porosity of porous refractory substrate 32 is greater than about 10 percent by volume (vol. %). The open pores directly affect properties such as slag resistance and permeability. In general, refractory substrates having a high porosity may have good crack inhibition and insulating properties, such as through inclusion of air voids, but low corrosion resistance. In contrast, lower porosity at surfaces of the refractory substrate may improve corrosion resistance, such as via less slag penetration, but may lower thermal shock resistance. Further, dense refractory materials having a low porosity may be expensive to fabricate. For example, dense refractory materials may be formed from relatively expensive processes, such as high temperature sintering, hot isostatic pressing, chemical vapor deposition (CVD), and other methods.

Porous refractory substrate 32 may have a porosity on a surface 36 that is sufficiently high that, if exposed to high temperature oxidative conditions, a surface portion of porous refractory substrate 32 would degrade. To protect against such high temperature oxidative conditions, portion 30 includes a surface layer 33 having a high density that resists penetration of oxidative species. Surface layer 33 is defined a surface portion of substrate 32 and a metal carbide phase 34 within the surface portion of porous refractory substrate 32.

FIG. 2B is a schematic expanded side view diagram of an example portion 30A of portion 30 of FIG. 2A. Surface 36 of porous refractory substrate 32 includes one or more surface voids 38. For example, surface 36 may include surface voids 38 that extend into a bulk of substrate 32. Surface voids 38 may include defects such as cracks, inherent structures such as surface pores, or other voids or roughness in the surface that extend into substrate 32 and may have relatively complex or irregular surfaces. For example, during fabrication of porous refractory substrate 32, voids between metal particles, such as silicon powder, may be exposed at surface 36 of substrate 32.

To protect substrate 32 from oxidation, portion 30 includes metal carbide phase 34 within voids 38 on one or more surfaces of substrate 32 that may be exposed to oxidizing species in a high temperature oxidative environment. In some examples, metal carbide phase 34 includes an amorphous and/or crystalline phase that maintains thermal and chemical stability at high temperatures, such as temperatures at or above about 1500° C. For example, metal carbide phase 34 may be stable at temperatures of up to about 3600° F. (about 2000° C.). In this context, “stable” may mean that phase 34 does not degrade into its constituent elements, does not react with carbon, and/or does not react with other elements or compounds present in the environment in which phase 34 is used including, but not limited to, oxidation, for a period of time (e.g., minutes or hours).

Metal carbide phase 34, in combination with a portion of substrate 32 near surface 36 within which metal carbide phase 34 extends, may define a dense surface layer 33 at surface 36 of substrate. Surface layer 33 may have any suitable thickness. In some examples, a thickness of surface layer 33 may be about 1 micrometer (μm) to about 100 μm, and may be non-uniform within portion 30. In some examples, a thickness of surface layer 33 may be determined by diffusion properties of the metal carbide system and/or deposition properties of the carbon.

Metal carbide phase 34 includes a metal carbide. Metal carbides may have high strength, wear-resistance, and temperature resistance, particularly as compared to substrate 32, and may be chemically compatible with underlying substrate 32. In some examples, the metal carbide includes at least one of silicon carbide, titanium carbide, or tungsten carbide. Metal carbide phase 34 extends across and fills surface voids 38 on surface 36 of porous refractory substrate 32 to form a dense, defect-free surface layer 33 that substantially encapsulates substrate 32.

In some examples, metal carbide phase 34 is formed by reacting a metal, such as in a metal slurry, with carbon in voids 38 of substrate 32. Metal carbide phase 34 fills surface voids 38 on surface 36 of porous refractory substrate 32. For example, metal carbide phase 34 may extend into voids 38 to an extent that metal carbide phase 34 seals voids 38, and may include only partially filling a particular void 38, such as extensive pores that extend into and interconnect below surface 36. Metal carbide phase 34 itself may have a low surface porosity, such as less than about 1%. As a result, metal carbide phase 34 may substantially seal surface voids (e.g., seal all surface voids or nearly all surface voids, such as 90% or more) in surface 36 of substrate 32 to form a dense surface layer 33.

In contrast to a porosity of porous refractory substrate 32, surface layer 33 that includes metal carbide phase 34 in surface voids 38 of substrate 32 may have a relatively low porosity, such that metal carbide phase 34 substantially seals porous refractory substrate 32. For example, a porosity of porous refractory substrate 32 may be greater than or equal to about 10 percent by volume (vol. %), while a porosity of surface layer 33 may be less than or equal to about 5 vol. %. As a result, porous refractory substrate 32 may be less susceptible to attack by oxidizing species than without metal carbide phase 34.

In some examples, metal carbide phase 34 is a silicon carbide phase. Silicon carbide may have properties that are particularly suited for a high temperature oxidative environment, including a high decomposition temperature, a relatively low crystallization temperature for one or more crystalline phases of metal carbide phase 34, a low coefficient of thermal expansion, ability to form a passivating oxide layer, and compatibility and adhesion with porous refractory substrate 32.

In some examples, a refractory component may further include a metal carbide coating on a surface of a porous refractory substrate. FIG. 2C is a schematic expanded side view diagram of an example portion 30B of portion 30 of FIG. 2A. In addition to including one or more surface voids 38, a portion adjacent to an outer surface of porous refractory substrate 32 may include a carbon matrix that is capable of reacting with metal of a metal slurry to form a metal carbide coating 35 on the outer surface of porous refractory substrate 32. For example, porous refractory substrate 32 may include refractory particles bonded by a carbon matrix. Metal carbide phase 34 and metal carbide coating 35, in combination with a portion of substrate 32 near surface 36 within which metal carbide phase 34 extends, may define a dense surface layer 33 at surface 36 of porous refractory substrate 32. In some examples, a thickness of metal carbide coating 35 at surface 36 of substrate 32 is less than about 50 microns, such as about 10 microns to about 20 microns. In some examples, metal carbide coating 35 is a silicon carbide coating.

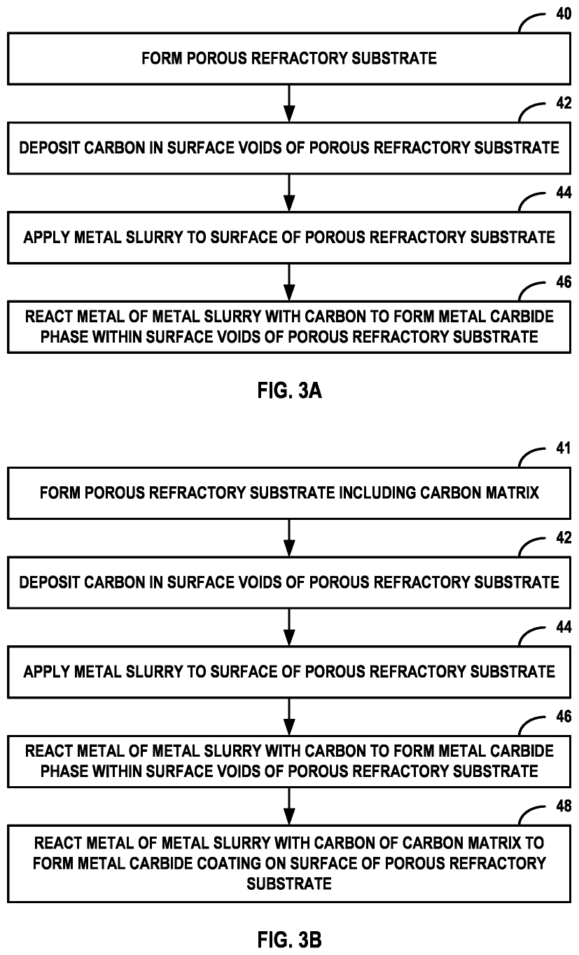

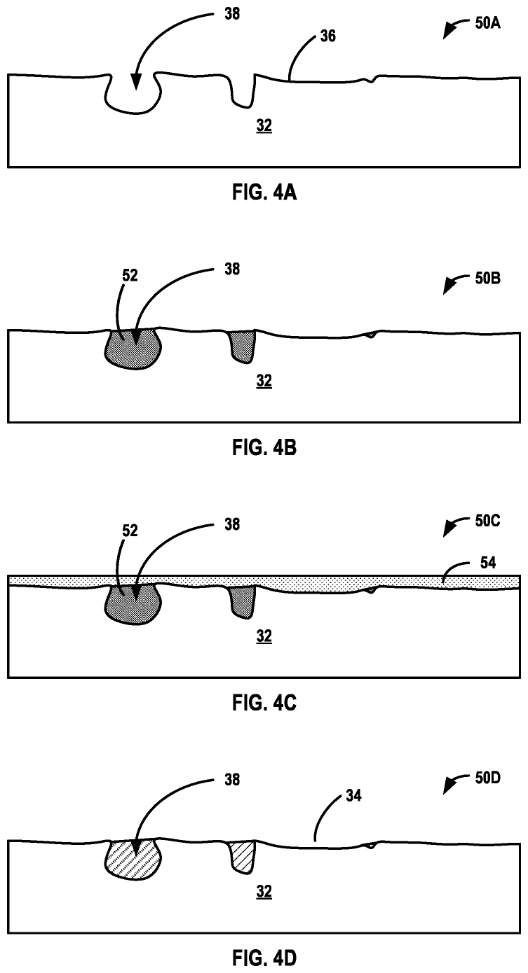

Refractory components described herein, such as refractory component 16 of FIG. 1 or portion 30 of FIG. 2A, portion 30A of FIG. 2B, or portion 30B of FIG. 2C above, may include a metal carbide phase formed in situ on porous refractory substrates to form a dense surface layer across the surface of the porous refractory substrate. FIGS. 3A and 3B are flow diagrams illustrating example techniques for forming a refractory component in accordance with the techniques of this disclosure. The example techniques of FIGS. 3A and 3B will be described with respect to FIGS. 4A-4D, which illustrate various steps for forming the refractory component.

The techniques of FIGS. 3A and 3B may be used to form a variety of refractory components. In some examples, the refractory component is a component of a foundry system, such that the refractory component defines an oxidation-resistant surface configured to contact molten metal. For example, the refractory component may include at least one of a ladle, a slide gate, a liner, or an interior portion of a vessel.

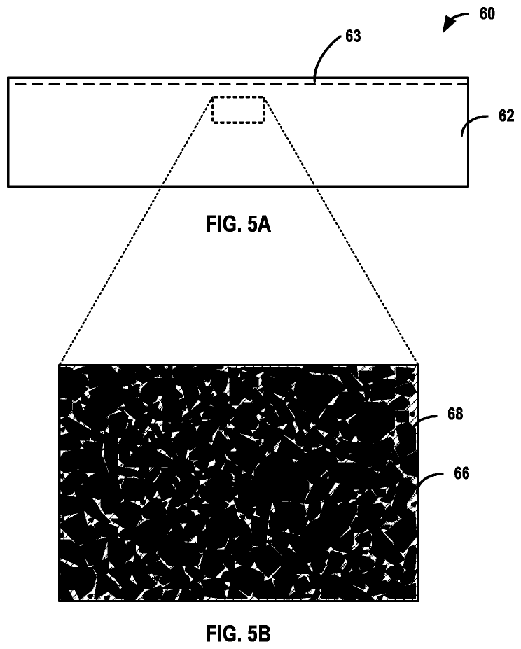

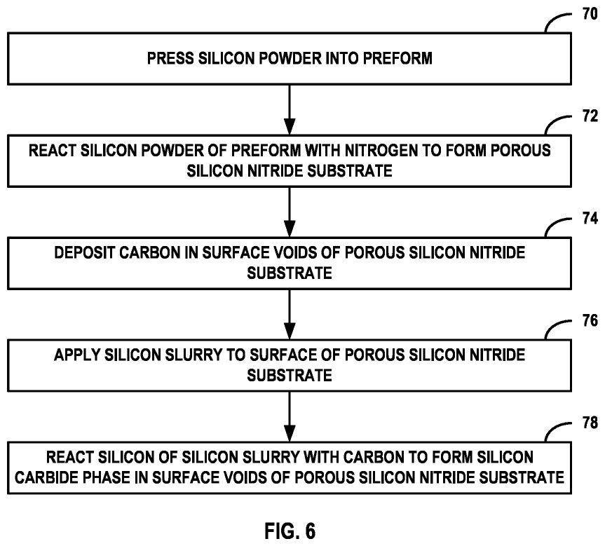

FIG. 3A is a flow diagram illustrating an example technique for forming a refractory component, such as illustrated in FIG. 2B. In some examples, the example technique includes, prior to deposition of a carbon layer, forming porous refractory substrate 32 (40). In some examples, porous refractory substrate 32 includes at least one of at least one of magnesia, alumina, silica, calcia, zirconia, or chamotte. In some examples, porous refractory substrate 32 may include a silicon-based reaction bonded ceramic, such as described in FIGS. 5A, 5B, and 6 below. A feedstock of materials used to form porous refractory substrate 32 and/or a process used to form porous refractory substrate 32 may be relatively inexpensive. For example, the feedstock may include ceramic particles reaction bonded to form a porous structure that is mechanically robust.

A porous refractory substrate, such as substrate 32, may include various surface voids 38 that, if left unsealed or partially sealed, may permit oxidizing species to penetrate into and react with substrate 32. For example, a porosity of porous refractory substrate 32 may be greater than or equal to about 10 percent by volume (vol. %). FIG. 4A is a cross-sectional side view diagram of a portion 50A of an example porous refractory substrate 32 that includes surface voids 38, formed in accordance with the techniques of this disclosure. Substrate 32 defines surface 36, which includes one or more surface voids 38. Voids 38 may include any irregularity or deviation from a general plane of surface 36 that may otherwise be susceptible to migration of oxidizing species. In some examples, voids 38 may include one or more pores, one or more cracks, and/or one or more surface projections or depressions. These voids 38 may be formed during formation of substrate 32. Voids 38 may have relatively complex surfaces that define relatively complex volumes that may be difficult to fill. For example, relatively large reactant particle size and/or high slurry viscosity may limit penetration of metal reactants into voids 38. In some examples, a size of surface voids 38 are greater than about 100 μm, such as, but not limited to, about 100 μm to about 1000 μm.

Referring back to FIG. 3A, the example technique includes depositing carbon in surface voids of a porous refractory substrate (42), such that carbon fills the surface voids of the porous refractory substrate. FIG. 4B is a cross-sectional side view diagram of a portion 50B of porous refractory substrate 32 and carbon 52, formed in accordance with the techniques of this disclosure. Depositing carbon 52 on surface 36 may include depositing carbon 52 on exposed portions of surface 36, including surfaces within voids 38 (e.g., at least partially fill the surface voids with carbon), such that carbon 52 may penetrate into surface voids 38 and extend across surface voids 38. Carbon 52 may be deposited until a desired coverage of surface voids 38 is reached.

In some examples, carbon 52 is formed from a solid carbon form, such as a carbon powder. In such examples, depositing carbon 52 within surface voids 38 may include applying carbon powder, such as from a slurry or mixture, to surface 36 of substrate 32. In some examples, depositing carbon layer 52 on surface 36 of substrate 32 includes applying a force to surface 36 to force and pack carbon powder into voids 38. For example, the force may include a normal force to surface 36 and/or any lateral forces to spread and/or fill voids 38. The force applied to carbon powder may force carbon powder into surface voids 38 prior to forming a metal carbide and pack carbon powder into surface voids 38, such that carbon powder is retained in surface voids 38. In some instances, a carrier medium may be applied to the carbon powder, such as a volatile medium to aid in dispersing carbon powder into voids 38. For example, carbon powder may be dispersed in the carrier medium to form a slurry corresponding to a relatively high packing. A variety of methods may be used to force and pack carbon powder into surface voids 38 including, but not limited to one or more of: rotary forces, such as polishing or abrasion; linear forces, such as spackling; manual forces, such as manual sanding (e.g., to generate and force carbon powder); or the like.

In some examples, carbon 52 is formed within surface voids 38 from a gaseous precursor, such as by using chemical vapor deposition (CVD). For example, depositing carbon 52 on surface 36 may include positioning substrate 32 in a reaction chamber, introducing a carbon precursor to an atmosphere in contact with surface 36 of substrate 32, and creating operating conditions, such as temperature and/or pressure conditions, that are configured to decompose the carbon precursor to form carbon 52 within surface voids 38. Various operating parameters of CVD may include, but are not limited to, temperature, pressure, precursor/gas inflow, precursor type (e.gg, methane, other hydrocarbons, or carbon source). Microstructural properties of carbon 52 that may result from controlling the various operating parameters include, but are not limited to, good bonding (e.g., surface conformance, adhesion, etc.) to the surface, uniformity of thickness, bridging of defects and voids, smooth surface, fast coating time, and the like. After deposition of carbon 52, surface 36 of substrate 32 may be smoother than prior to deposition of carbon 52. For example, as shown in FIG. 4B, carbon may be continually deposited on exposed surfaces of carbon layer 52 until voids 38 are filled.

Referring back to FIG. 3A, the example technique includes applying a metal slurry to the surface of the porous refractory substrate following the deposition of the carbon (44). FIG. 4C is a cross-sectional side view diagram of a portion 50C of porous refractory substrate 32, carbon 52 within surface voids 38 of substrate 32, and a metal slurry 54 overlying substrate 32, formed in accordance with the techniques of this disclosure. While illustrated as a metal slurry 54, the metal may be applied in any form, including as a liquid or gas.

Metal slurry 54 may include metal particles in an application medium. In some examples, the metal particles of metal slurry 54 include at least one of silicon, titanium, or tungsten. The metal particles may be coated by a thin layer of a metal oxide, such as may be formed in an oxidizing atmosphere during formation or shelf-life of the metal particles. For example, a relatively pure feedstock of metal particles may be prohibitively expensive due to inert storage, such that use of metal particles that include a metal oxide film may broaden available feedstocks of material for the metal particles and/or reduce a cost of the metal particles.

Referring back to FIG. 3A, the example technique includes reacting a metal of the metal slurry with the carbon within the surface voids (46), such that the metal carbide phase fills the surface voids on the surface of the porous refractory substrate. As a result, a surface portion of the refractory component may have a substantially lower porosity. For example, a porosity of the surface portion that includes the metal carbide phase may be less than about 5 vol. %. FIG. 4D is a cross-sectional side view diagram of a portion 50D of porous refractory substrate 32 and metal carbide phase 34, formed in accordance with the techniques of this disclosure. To react the metal of metal slurry 54 with carbon 52, the metal may be fluidized (e.g., melted or sublimated) such that the metal may infiltrate into carbon 52 and react with carbon 52 to form a metal carbide. Metal carbide phase 34, in combination with a surface portion of substrate 32 into which metal carbide phase 34 extends, may form a continuous surface layer 33 in which metal carbide phase 34 substantially seals surface voids 38 of substrate 32. In some examples, the metal of metal slurry 54 includes silicon, and the metal carbide of metal carbide phase 34 includes silicon carbide. Surface voids 38 may be filled with carbon particles that are packed or otherwise deposited such that carbon 52 forms a porous phase of carbon 52 in surface void 38, such as a packing volume from about 50 volume percent (vol. %) to about 60 vol. %. The porosity of the porous phase of carbon 52 permits liquid metal to flow in the spaces in between the carbon particles or grains and convert the compact carbon 52 into metal carbide. As a result, a reaction between carbon 52 and the metal may not be substantially diffusion limited.

The metal may be applied to surface 36 of substrate 32 until the reaction ends, such as by metal evaporation or exhaustion or conversion of any remaining carbon 52 to metal carbide phase 34. For example, any remaining metal on surface 36 may be removed, such as through evaporation. The resulting metal carbide phase 34 may be a relatively homogeneous metal carbide that fills voids 38. In some examples, a depth of metal carbide phase 34 into surface 36 of substrate 32 (e.g., a thickness of surface layer 33) is from about 10 microns to about 1000 microns.

Reaction of the metal of metal slurry 54 with carbon 52 may be performed under stoichiometric excess of the metal, such that the resulting metal carbide phase 34 is metal-rich. Metal-rich may include a metal carbide phase that includes excess free metal. For example, a metal-rich metal carbide phase may include a stoichiometric ratio of the metal to the carbon of carbon 52 that is greater than 1:1, such as greater than about 1.001:1. By performing the reaction at stoichiometric excess of the metal, the resulting metal carbide phase 34 may include excess metal. During formation of metal carbide phase 34 or during operation of the refractory component (e.g., as a component), the excess metal may form a metal oxide. In some instances, the metal oxide may form a passivation layer that further protects substrate 32. In some instances, the metal oxide may perform a self-healing function for metal carbide phase 34. For example, the metal oxide may migrate into small cracks that may form during operation, such as due to mismatch in coefficient of thermal expansion (CTE) or volumetric expansion, and seal the cracks.

In some examples, reacting the metal of metal slurry 54 with the carbon of carbon 52 includes heating surface 36 of substrate 32, including carbon 52 and metal slurry 54, above a melting point of the metal and maintaining a vapor pressure of the metal at surface 36 of substrate 32 in stoichiometric excess. A variety of parameters, such as a temperature at surface 36, a concentration (e.g., as indicated by pressure) of the metal at surface 36, and a time of reaction, may be controlled to maintain the metal at stoichiometric excess and encourage migration of the metal into, and reaction with, carbon 52.

In some examples, techniques described herein may be used with porous refractory substrates that include a carbon matrix, thereby forming a protective metal carbide coating in addition to sealing the porous refractory substrate with a metal carbide phase. FIG. 3B is a flow diagram illustrating an example technique for forming a refractory component, such as illustrated in FIG. 2C. Unless otherwise described, particular steps of FIG. 3A may correspond to particular steps of FIG. 3B.

In some examples, the example technique includes, prior to deposition of a carbon layer, forming porous refractory substrate 32 to include a carbon matrix (41). For example, porous refractory substrate 32 may include refractory particles, such as magnesia, alumina, silica, calcia, zirconia, or chamotte, bonded in a carbon matrix. As a result, a surface portion of porous refractory substrate 32 includes a carbon matrix that is available for subsequent reaction with metal of a metal slurry to form a metal carbide coating.

The example technique includes depositing carbon in surface voids of porous refractory substrate 32 (e.g., described in step 42 of FIG. 3A), applying metal slurry 54 to surface 36 of porous refractory substrate 32 (e.g., described in step 44 of FIG. 3A), and reacting metal of metal slurry 54 with carbon of carbon 52 to form metal carbide phase 34 (e.g., described in step 46 of FIG. 3A). Due to the reactive carbon matrix at the surface portion of porous refractory substrate 32, the technique includes reacting the metal of metal slurry 52 with carbon of the carbon matrix of porous refractory substrate 32 to form metal carbide coating 35 on an outer surface of porous refractory substrate 32 (48).

In some instances, this reaction may be limited by diffusion of the metal into the carbon matrix. As the metal reacts with the carbon of the carbon matrix of porous refractory substrate 32 and forms a metal carbide, the newly formed metal carbide may form a diffusion barrier separating the reactants (e.g., carbon and metal), which may stop the thickening and further creation to form thicker metal carbides (e.g., by preventing metal from further penetrating into a depth of the carbon matrix and/or preventing diffusion of carbon out of the carbon matrix to react with the metal). For example, the metal carbide may have a low surface porosity, such as less than about 1%. The metal may be applied to surface 36 of porous refractory substrate 32 until the reaction ends either by diffusion limitation, metal evaporation or exhaustion, or both. The resulting metal carbide coating 35 may be a relatively homogeneous metal carbide layer having a relatively uniform thickness that may include some deviations to fill voids 38. In some examples, a microstructure of metal carbide coating 35 may be different from a microstructure of metal carbide phase 34 in voids 38. For example, a composition or microstructure of carbon in voids 38 may be different from a composition or microstructure of carbon in the carbon matrix of substrate 32, such that the resulting microstructure of the metal carbide coating 35 or phase 34 may be different. In some examples, the microstructure of the metal carbide coating 35 and phase 34 may be substantially the same, such as if a composition or microstructure of the carbon from which the metal carbide is derived is substantially the same. In some examples, a thickness of metal carbide coating 35 at surface 36 of substrate 32 is less than about 50 microns, such as about 10 microns to about 20 microns.

In some examples, refractory components described herein may include a porous refractory substrate that includes a reaction bonded silicon-based substrate. For example, the porous refractory substrate may include at least one of a reaction bonded silicon nitride, a reaction bonded silicon carbide, or a nitride bonded silicon carbide. FIG. 5A is a cross-sectional expanded side view diagram of a portion of an example refractory component formed in accordance with the techniques of this disclosure. Portion 60 includes a reaction bonded silicon nitride (RBSN) substrate 62 and a surface layer 63 near a surface of substrate 62 that includes silicon carbide phase 64 and a surface portion of RBSN substrate 62. Surface layer 63 may be similar to surface layer 33 described in FIGS. 1-4D, with silicon as the metal in metal carbide phase 34.

Like porous refractory substrate 32 of FIGS. 1-4D, porous RBSN substrate 62 may have good mechanical properties (e.g., suitable for metal processing or aerospace applications) and a relatively high porosity, such as greater than or equal to 10 vol. %. FIG. 5B is a cross-sectional expanded side view diagram of portion 60 of porous RBSN substrate 62 of the example refractory component of FIG. 5A formed in accordance with the techniques of this disclosure. Substrate 62 includes a silicon nitride phase 68 and pores 66 within silicon nitride phase 68. In some examples, substrate 62 includes an unreacted silicon phase in silicon nitride phase 68. However, in other examples, substrate 62 may be substantially all silicon nitride phase 68. As will be described further below, silicon nitride phase 68 may be formed from previously unreacted silicon in silicon particles. Silicon nitride formed from the silicon may expand into pores between the silicon particles to at least partially fill the pores and bind the converted silicon nitride particles together. As a result, substrate 62 may have high mechanical strength, while also including some remaining porosity.

FIG. 6 is a flow diagram illustrating an example technique for forming a refractory component that includes a porous RBSN substrate and a silicon carbide phase in accordance with the techniques of this disclosure. The technique of FIG. 6 will be described with respect to FIGS. 5A and 5B, which illustrate a final form of the refractory substrate. The technique of FIG. 6 includes pressing silicon powder into a preform (70). Pressing silicon powder into a preform may include pressure casting silicon powder into a mold having a predetermined shape corresponding to a shape of the refractory component. The porosity of the resulting pressure casted silicon powder may be relatively high compared to a desired porosity of the resulting porous RBSN substrate. In some examples, the porosity of the pressure casted silicon powder is greater than about 25 vol. %.

The technique of FIG. 6 includes reacting the silicon powder of the preform with nitrogen gas to form a porous RBSN substrate that includes silicon nitride (72). Reacting the silicon powder with the nitrogen gas may include heating the silicon nitride below a melting temperature of the silicon (e.g., about 1400° C.). This reaction converts substantially all (e.g., greater than about 95 wt. %) of the silicon particles into silicon nitride particles and binds that silicon nitride particles together to form silicon nitride phase 68. Without being limited to any particular theory, the newly formed surface of the silicon nitride particle may be very active energetically, and thereby more susceptible to reducing its surface than a ball milled surface of a high temperature formed silicon nitride particle, resulting in lower temperature sintering of particles. Additionally or alternatively, there may be expansion of a lattice of the silicon from the nitrogen incorporation that may assist in closing the gaps between the silicon nitride particles and consolidating the silicon nitride particles together. The porosity of the resulting porous RBSN substrate 62 may be relatively low compared to a porosity of the preform of pressure casted silicon powder. In some examples, the porosity of porous RBSN substrate 62 is greater than about 20 vol. %.

The technique of FIG. 6 includes depositing carbon in surface voids of the porous silicon nitride substrate (74), applying a silicon slurry to the surface of the porous silicon nitride substrate (76), and reacting silicon of the silicon slurry with the carbon to form a silicon carbide phase in the surface voids of the porous silicon nitride substrate (78). These steps 74-78 may be similar to steps 42-46 of FIG. 3, with silicon as the metal in the metal slurry. As a result, the technique of FIG. 6 may produce a refractory component having a mechanically robust silicon nitride core and a dense protective surface layer that includes silicon carbide in the surface voids of the silicon nitride.

In some examples, the technique of FIG. 6 may be performed as a substantially two-step process. For example, forming a porous RBSN substrate, as illustrated in steps 70 and 72, may be performed sequentially in a same mold and heating apparatus, while forming a silicon carbide phase in surface voids of the porous RBSN substrate, as illustrated in steps 74-78, may be performed sequentially in a same spray and heating apparatus.

Example 1: A method for making a refractory component includes depositing carbon within surface voids of a refractory substrate, wherein a melting point of the refractory substrate is greater than or equal to about 1500 degrees Celsius (° C.); applying a metal slurry to the refractory substrate following the deposition of the carbon; and reacting a metal of the metal slurry with the carbon to form a metal carbide phase within the surface voids of the refractory substrate.

Example 2: The method of example 1, wherein the metal carbide phase and a surface portion of the refractory substrate define a surface layer, wherein a porosity of the surface portion of the refractory substrate is greater than about 10 percent by volume (vol. %), and wherein a porosity of the surface layer is less than about 5 vol. %.

Example 3: The method of any of examples 1 and 2, wherein the refractory substrate comprises at least one of at least one of magnesia, alumina, silica, calcia, zirconia, or chamotte.

Example 4: The method of any of examples 1 through 3, wherein the metal of the metal slurry comprises silicon, and wherein the metal carbide phase comprises silicon carbide.

Example 5: The method of any of examples 1 through 4, wherein the refractory substrate comprises silicon nitride.

Example 6: The method of any of examples 1 through 5, further comprising, prior to depositing the carbon, forming the refractory substrate.

Example 7: The method of example 6, wherein the refractory substrate comprises at least one of a reaction bonded silicon nitride, a reaction bonded silicon carbide, or a nitride bonded silicon carbide.

Example 8: The method of any of examples 6 and 7, wherein forming the refractory substrate comprises: pressure casting silicon powder into a mold having a predetermined shape corresponding to a shape of the refractory component; and reacting the silicon powder with nitrogen gas to form the refractory substrate comprising silicon nitride.

Example 9: The method of example 8, wherein reacting the silicon powder with the nitrogen gas includes heating the silicon nitride below a melting temperature of the silicon.

Example 10: The method of any of examples 8 and 9, wherein a porosity of the pressure casted silicon powder is greater than about 20 vol. %.

Example 11: The method of any of examples 8 through 10, wherein a porosity of the refractory substrate is greater than about 25 vol. %.

Example 12: The method of any of examples 1 through 11, wherein a surface portion of the refractory substrate includes a carbon matrix, and wherein the method further comprises reacting the metal of the metal slurry with carbon of the carbon matrix to form a metal carbide coating on an outer surface of the refractory substrate.

Example 13: The method of any of examples 1 through 12, wherein the refractory component is a component of a foundry system, wherein the refractory component defines an oxidation-resistant surface configured to contact molten metal, and wherein the refractory component comprises at least one of a ladle, a slide gate, a liner, or an interior portion of a vessel.

Example 14: An article of a foundry system includes a refractory component defining an oxidation-resistant surface configured to contact molten metal, wherein the refractory component comprises: a refractory substrate, wherein a melting point of the refractory substrate is greater than or equal to about 1500 degrees Celsius (° C.); and a metal carbide phase within surface voids of the refractory substrate.

Example 15: The article of example 14, wherein the metal carbide phase and a surface portion of the refractory substrate define a surface layer, wherein a porosity of the surface portion of the refractory substrate is greater than about 10 percent by volume (vol. %), and wherein a porosity of the surface layer is less than about 5 vol. %.

Example 16: The article of any of examples 14 and 15, wherein the refractory substrate comprises at least one of magnesia, alumina, silica, calcia, ferric oxide, titania, silicates, zirconia, or chamotte.

Example 17: The article of any of examples 14 through 16, wherein the metal carbide phase comprises silicon carbide.

Example 18: The article of any of examples 14 through 17, wherein the refractory substrate comprises silicon nitride.

Example 19: The article of any of examples 14 through 18, wherein the refractory substrate includes a carbon matrix, and wherein the refractory component further comprises a metal carbide coating on an outer surface of the refractory substrate.

Example 20: The article of any of examples 14 through 19, wherein the high temperature article comprises a vessel, wherein the oxidation-resistant surface of the refractory component is configured to contact molten metal, and wherein the refractory component comprises at least one of a ladle, a slide gate, a liner, or an interior portion of a vessel.

Various examples have been described. These and other examples are within the scope of the following claims.

What is claimed is:

1. A method for making a refractory component, the method comprising:
depositing carbon within surface voids of a refractory substrate, wherein a melting point of the refractory substrate is greater than or equal to about 1500 degrees Celsius (° C.);
applying a metal slurry to the refractory substrate following the deposition of the carbon; and
reacting a metal of the metal slurry with the carbon to form a metal carbide phase within the surface voids of the refractory substrate.

2. The method of claim 1,
wherein the metal carbide phase and a surface portion of the refractory substrate define a surface layer,
wherein a porosity of the surface portion of the refractory substrate is greater than about 10 percent by volume (vol. %), and
wherein a porosity of the surface layer is less than about 5 vol. %.

3. The method of claim 1, wherein the refractory substrate comprises at least one of at least one of magnesia, alumina, silica, calcia, zirconia, or chamotte.

4. The method of claim 1,
wherein the metal of the metal slurry comprises silicon, and
wherein the metal carbide phase comprises silicon carbide.

5. The method of claim 1, wherein the refractory substrate comprises silicon nitride.

6. The method of claim 1, further comprising, prior to depositing the carbon, forming the refractory substrate.

7. The method of claim 6, wherein the refractory substrate comprises at least one of a reaction bonded silicon nitride, a reaction bonded silicon carbide, or a nitride bonded silicon carbide.

8. The method of claim 6, wherein forming the refractory substrate comprises:
pressure casting silicon powder into a mold having a predetermined shape corresponding to a shape of the refractory component; and
reacting the silicon powder with nitrogen gas to form the refractory substrate comprising silicon nitride.

9. The method of claim 8, wherein reacting the silicon powder with the nitrogen gas includes heating the silicon nitride below a melting temperature of the silicon.

10. The method of claim 8, wherein a porosity of the pressure casted silicon powder is greater than about 20 vol. %.

11. The method of claim 8, wherein a porosity of the refractory substrate is greater than about 25 vol. %.

12. The method of claim 1,
wherein a surface portion of the refractory substrate includes a carbon matrix, and
wherein the method further comprises reacting the metal of the metal slurry with carbon of the carbon matrix to form a metal carbide coating on an outer surface of the refractory substrate.

13. The method of claim 1,
wherein the refractory component is a component of a foundry system,
wherein the refractory component defines an oxidation-resistant surface configured to contact molten metal, and
wherein the refractory component comprises at least one of a ladle, a slide gate, a liner, or an interior portion of a vessel.

14. An article of a foundry system, the article comprising:
a refractory component defining an oxidation-resistant surface configured to contact molten metal, wherein the refractory component comprises:
a refractory substrate, wherein a melting point of the refractory substrate is greater than or equal to about 1500 degrees Celsius (° C.); and
a metal carbide phase within surface voids of the refractory substrate.

15. The article of claim 14,
wherein the metal carbide phase and a surface portion of the refractory substrate define a surface layer,
wherein a porosity of the surface portion of the refractory substrate is greater than about 10 percent by volume (vol. %), and
wherein a porosity of the surface layer is less than about 5 vol. %.

16. The article of claim 14, wherein the refractory substrate comprises at least one of magnesia, alumina, silica, calcia, ferric oxide, titania, silicates, zirconia, or chamotte.

17. The article of claim 14, wherein the metal carbide phase comprises silicon carbide.

18. The article of claim 14, wherein the refractory substrate comprises silicon nitride.

19. The article of claim 14,
wherein the refractory substrate includes a carbon matrix, and
wherein the refractory component further comprises a metal carbide coating on an outer surface of the refractory substrate.

20. The article of claim 14,
wherein the high temperature article comprises a vessel,
wherein the oxidation-resistant surface of the refractory component is configured to contact molten metal, and
wherein the refractory component comprises at least one of a ladle, a slide gate, a liner, or an interior portion of a vessel.
